(19) United States
(12) Patent Application Publication
(10) Pub. No.: US 2014/0283626 A1
(43) Pub. Date: Sep. 25, 2014

(54) Tubular membrane gas and volatile compounds sampler for fluid introduction at atmospheric to high pressure

(71) Applicants: Gary Michael McMurtry, Honolulu, HI (US); Daniel N. Kokubun, Waipahu, HI (US)

(72) Inventors: Gary Michael McMurtry, Honolulu, HI (US); Daniel N. Kokubun, Waipahu, HI (US)

(21) Appl. No.: 13/999,653

(22) Filed: Mar. 14, 2014

Related U.S. Application Data
(60) Provisional application No. 61/852,279, filed on Mar. 15, 2013.

(51) Int. Cl. G01N 1/10; H05B 3/00; G01K 7/22

(52) U.S. Cl. CPC G01N 1/10; G01K 7/22; H05B 3/00
USPC 73/863.23; 374/183; 219/522

(57) ABSTRACT

A high-transmittance sampler of dissolved gases and volatile organic compounds (VOC) is described that is based upon a thin polymer membrane with tubular geometry. Very high hydrostatic pressures are maintained by surrounding the polymer tube or coating with sintered material. The sintered material can be surrounded by additional metal support, with holes for passage of molecules into the vacuum chamber of a sensor system such as a mass spectrometer. A method is described that uses the plastic behavior of the polymer to seal the ends of the sampler against leakage. Other features of the sampler are compact size, varied vacuum housing geometry, and provision for heat with regulation to the vacuum assembly of the sampler. The hydrodynamic design of fluid flow through the sampler and the compact and variable vacuum geometry allow greater response and sensitivity than previous samplers, and allow its operation to very high hydrostatic pressures.

### CROSS-REFERENCE TO RELATED APPLICATIONS

“This application claims the benefit of Provisional Patent Application Ser. No. 61/852,279, filed 2013 Mar. 15 by the present inventors.”

### FEDERALLY SPONSORED RESEARCH

Not applicable.

### SEQUENCE LISTING OR PROGRAM

No listing.

### BACKGROUND

### Field of Invention

Two basic geometries for membrane introduction mass spectrometry (MIMS) have been considered, flat sheet and tubing. Both geometries have been extensively used by previous work in the laboratory and in the field, including underwater MIMS applications. Membrane introduction mass spectrometry has been described by: Kibelka, et al., 2004, in “Field-deployed underwater mass spectrometers for investigations of transient chemical systems,” Talanta 64, 961-969, which is hereby incorporated by reference. Membrane introduction mass spectrometry has been described by: McMurtry et al., “A Deep-Ocean Mass Spectrometer to Monitor Hydrocarbon Seeps and Pipelines,” Proceedings of the Offshore Mechanics and Arctic Engineering Conference, American Society of Mechanical Engineers, OMAE 2005-67146, p. 1-8 (2005), which is hereby incorporated by reference. Membrane introduction mass spectrometry has been described by: Short et al., “Detection and quantification of chemical plumes using a portable underwater membrane introduction mass spectrometer,” Trends in Anal. Chem., 25: 7 (2006), which is hereby incorporated by reference. We have extensive experience in the use of flat membranes, as these geometries provide a more straightforward approach to high-pressure or deep-ocean underwater mass spectrometer (MS) applications. U.S. Pat. No. 7,385,191 to McMurtry, et al. (2008), which is hereby incorporated by reference, discloses high-pressure membrane introduction for a mass spectrometer.

Disadvantages of flat sheet membranes include practical limits to exposure area and sample dead-volume issues that can both limit detection of compounds of interest. Therefore, we were interested in pursuing any analytical advantages that may result from the use of tubing geometries. Although their use presents engineering challenges to high-pressure or deep-ocean applications, tubing membranes offer several advantages toward improved detection sensitivity, among them increased exposure area to the analyte and minimization of sample dead-volume effects, especially if used in the flow-through versus flow-over tubing geometry option. An example is given by: LaPlack et al., 1990, “Membrane mass spectrometry for the direct trace analysis of volatile organic compounds in air and water,” Anal. Chem. 62, 1265-1271, which is hereby incorporated by reference.

A flow-over tubular MIMS sampler assembly based upon PDMS polymer that is stretched or coated over a sintered glass rod is described by Bell et al., 2007, “Calibration of an in situ membrane inlet mass spectrometer for measurements of dissolved gases and volatile organics in seawater,” Environ. Sci. Technol. 41, 8123-8128, which is hereby incorporated by reference. Heaters placed within the metal assembly allow for heating of the water that passes over the PDMS as dissolved gases and volatile organic compounds (VOC) are passed isothermally though the membrane into the vacuum chamber of a mass spectrometer (MS). The depth capability of this system appears to be limited to 200 m water depth because of hydrostatic pressure (crush) effects on the membrane and sintered glass rod.

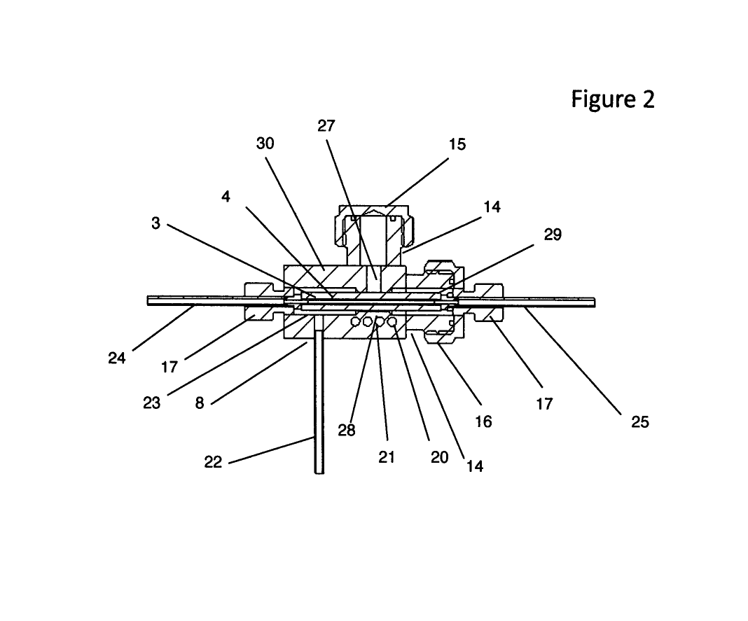

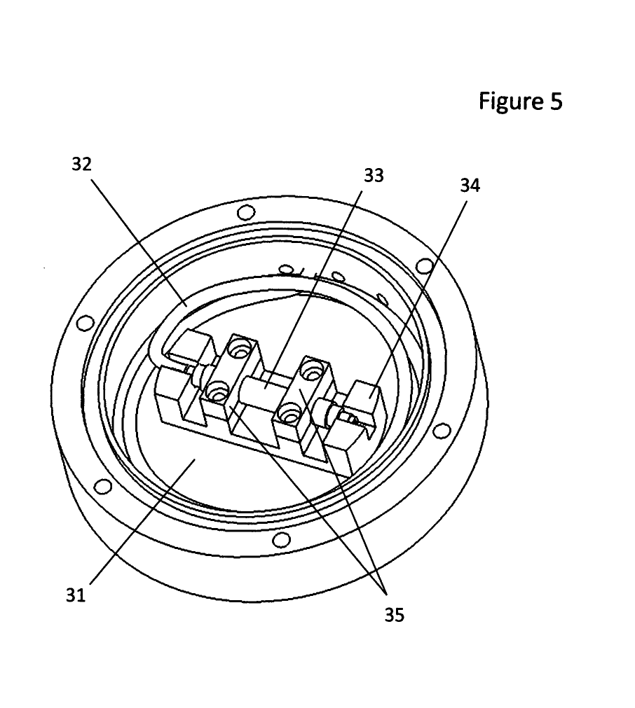

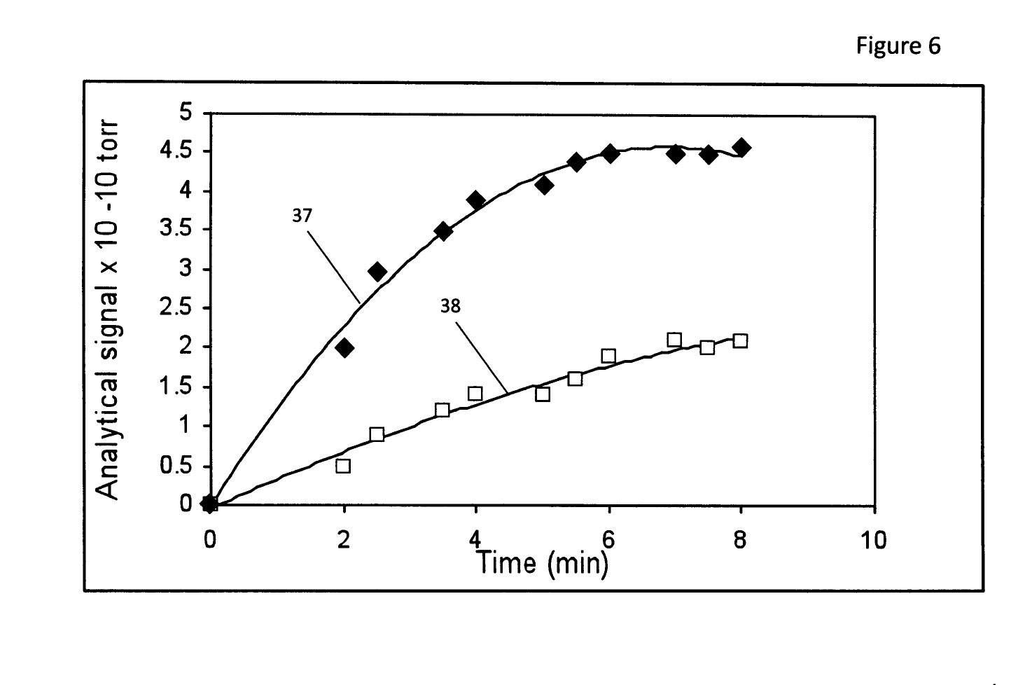

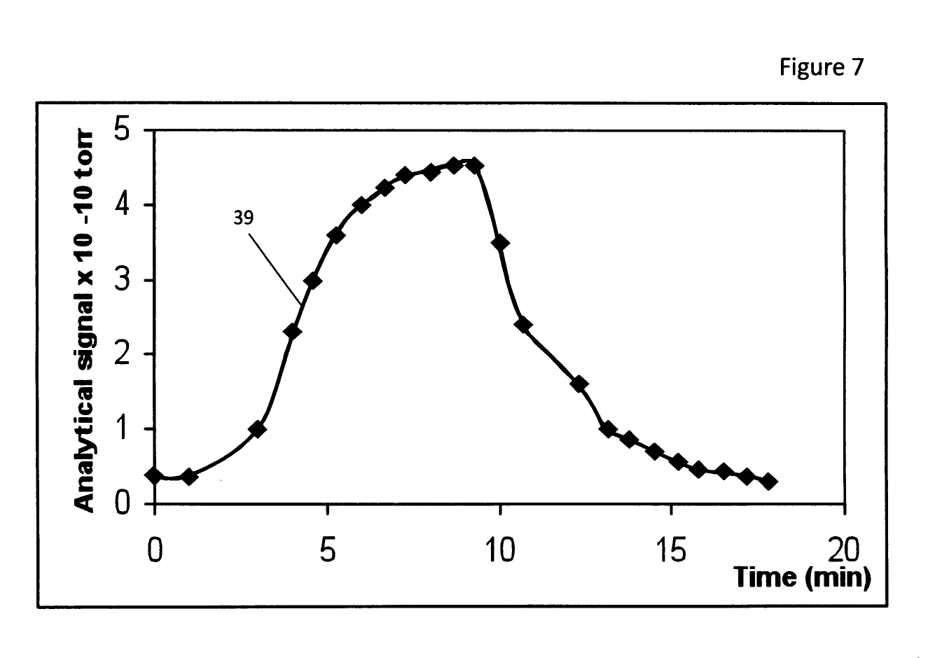

We have designed and bench tested a high-pressure heated MIMS assembly for hollow fiber or tubular membranes, called herein the Mark IV (FIGS. 2-4). A further design embodiment of the invention is presented in FIG. 5. The Mark IV is a flow-through design that features both compact size and higher MS signal sensitivity, which has been shown by LaPack et al. to be up to 50 times more sensitive that other MIMS designs based upon tubular membranes. Our preliminary experimental results with the Mark IV prototype are very encouraging, especially in producing relatively rapid VOC response time (FIGS. 6-7). A major advance is the ability to perform MIMS with this geometry at high hydrostatic pressure without leaks. Another advance is the ability to hold the membrane shape regardless of the variation in, or absolute amount of, hydrostatic pressure applied.

### SUMMARY

The invention pertains to the field of membrane introduction of fluid samples to various kinds of analytical instruments for the measurement of dissolved gases and volatile organic compound (VOC) concentrations. One such analytical approach is membrane introduction mass spectrometry (MIMS). It further involves analytical work in situ under extreme or harsh environmental conditions.

### REFERENCE NUMERALS IN DRAWINGS

1. Inward fluid flow direction
2. Outward fluid flow direction
3. Tubular cast or coating of polymer membrane
4. Hollow sintered rod
5. Pressure backing with drilled egress holes
6. Molecular flow to surrounding vacuum chamber
7. Weld
8. Epoxy seal
9. O-ring
10. Sample Inlet Port
11. Sample Outlet Port
12. Assembly access port
13. Thermal pressure screw port
14. Swagelok™ VCR fitting body
15. Swagelok™ VCR fitting cap
16. Swagelok™ VCR fitting cap with attached Swagelok™ UltraTorr™ fitting
17. Swagelok™ UltraTorr™ fitting body
18. Swagelok™ UltraTorr™ fitting cap
19. Swagelok™ UltraTorr™ compression insert fitting
20. Heater
21. Thermistor
22. Vacuum port
23. Vacuum chamber
24. Sample inlet tube
25. Sample outlet tube
26. Polymer membrane under compression
27. Thermal contact area
28. Thermal pressure screw
29. Machined tubing adapter
30. Body
31. Vacuum chamber pressure housing endcap
32. Curved sample inlet tube of vacuum chamber embodiment
33. Gas transmittance structure
34. Body of alternate embodiment
35. Alternate body hold down clamp
36. Detail
37. Membrane Inlet Mass Spectrometer (MIMS) analytical response of invention to dissolved chloroform over time, 1-ppm concentration
38. MIMS analytical response of invention to dissolved toluene over time, 1-ppm concentration
39. MIMS analytical response of invention to dissolved chloroform over time. At 10 minutes elapsed time, the 1-ppm solution was replaced by distilled water

### DESCRIPTION OF THE DRAWINGS

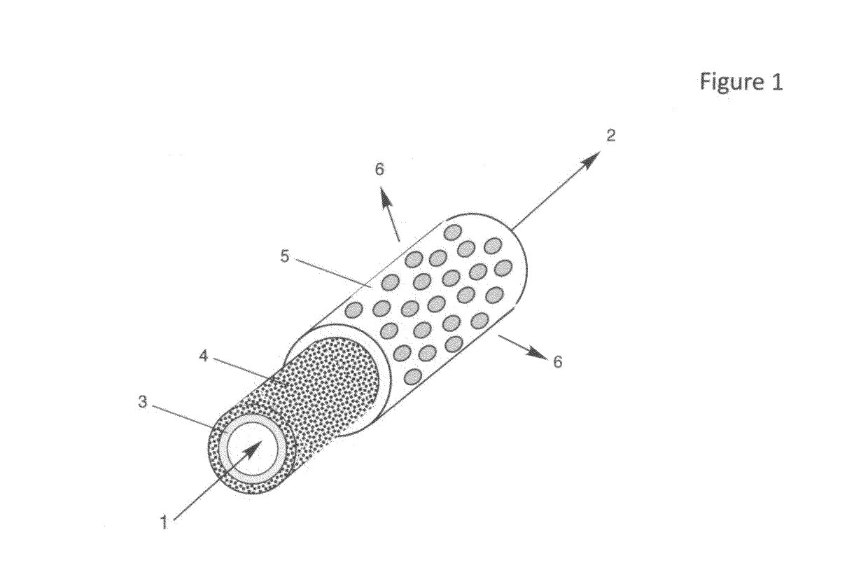

FIG. 1

Schematic view of a high-transmittance membrane introduction system for fluid flow from one atmosphere to very high hydrostatic pressure. This design depicts dissolved gases and volatile organic compound (VOC) introduction into a vacuum system of a mass spectrometer, gas chromatograph (GC) or GCMS from a flowing fluid. Fluid is introduced through a tubular entrance and exits through a tubular extension, not shown, on the opposite side of the vacuum chamber assembly. Arrows 1, 2 indicate the direction of fluid flow. Dissolved gases and volatile organic compounds (VOCs) transfer into the vacuum through a thin, even coating, a composite of coatings or preformed tubing walls 3 made of polymers such as poly dimethyl silicone (PDMS), Teflon™, or the like. A porous, sintered material 4 provides initial support against the applied pressure of the fluid. Further support against the hydrostatic pressure of the fluid is provided by a metal tube, which surrounds the sintered material in close contact with it 5. This supporting tubing material has holes or slots drilled into it for ease of transmittance of the gases or VOC as molecular flow 6 into the surrounding vacuum chamber 23.

FIG. 2

Cross sectional view of prototype used to test the invention, with major features labeled. This prototype was connected to the vacuum of a quadrupole mass spectrometer detector. The thermal pressure screw 28 makes pressure contact with the porous, sintered material 4 or the surrounding metal tube 5, not used with this particular embodiment. A thermal contact area 27 is provided by close contact with the metal body 30 of the vacuum chamber 23 assembly on the opposite side of the thermal pressure screw 28 that is located above the heaters 20. The vacuum chamber 23 surrounds the tubing 3, and the sintered material 4. The vacuum chamber 23 in this embodiment is designed for low volume, to enable faster and higher-pressure analytical response by the mass spectrometer.

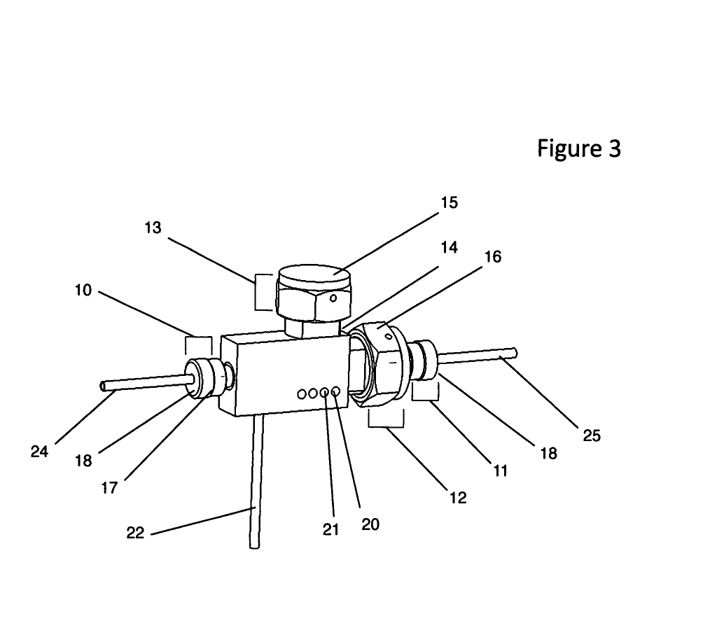

FIG. 3

Design view of prototype (herein called the Mark IV) used to test the invention, with major features labeled. This prototype was connected to the vacuum of a quadrupole mass spectrometer detector. High vacuum fittings 17, 18 with integral o-ring seals, not shown, provide a high vacuum seal against the outside diameter of the entrance 24 and exit 25 tubing. High vacuum fittings are used for vacuum seal of the assembly access port 12 and the thermal pressure screw port 13. Through-holes are drilled into the metal body 30 for emplacement of the heaters 20 and thermistor temperature probes 21 with high-temperature cement 8. A vacuum port 22 to the mass spectrometer (or gas chromatograph mass spectrometer, GCMS) is sealed to the body of the vacuum chamber assembly.

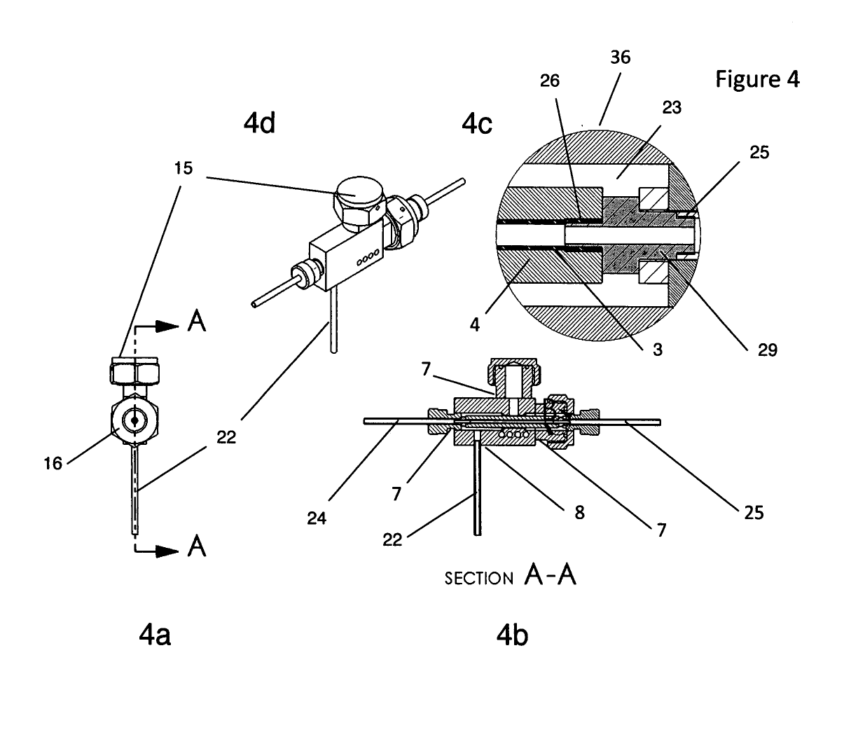

FIG. 4a

End view solid design drawing of a tubular membrane sampler for fluids introduced at atmospheric to high pressure of one preferred embodiment of the invention.

FIG. 4b

Cross sectional through A-A of FIG. 4a of a tubular membrane sampler for fluids introduced at atmospheric to high pressure, showing design details of the invention, including points for application of vacuum seals by use of epoxy resin 8 and metal welds 7.

FIG. 4c

Detailed plan view of membrane gasket seal on tube exit end of a tubular membrane sampler for fluids introduced at atmospheric to high pressure. Shows compression sealing of the polymer membrane tube 3 between machined tubing adapter 29 and inner bore of the hollow sintered rod 4. This places the polymer membrane under compression 26 forming a compression gasket at 26.

FIG. 4d

Solid design of tubular membrane sampler for fluids introduced at atmospheric to high pressure of one preferred embodiment of the invention of FIG. 3 rotated to show a more frontal and top view.

FIG. 5

A top view, tilted about 45 degrees, of a tubular membrane sampler for fluids centered within a round vacuum housing endcap 31. This round vacuum housing is appropriate for perpendicular or cross-wise containment within the cylindrical external pressure housing of an underwater instrument, for example. The gas transmittance structure 33 is clamped inside the disc-shaped vacuum housing endcap between the alternate body 34 and two hold down clamps 35. On the backside of the housing endcap, not shown, is an external heater block. The sample goes in through the stainless steel or titanium tube that is coiled inside the vacuum housing 32. The sample goes out through a similar exit tube, which is not shown in the drawing. The coiled up tubing allows the change-out of the membrane, by removing the two hold down clamps, pulling out the gas transmittance structure, and replacing the membrane therein.

FIG. 6

Graph showing the development of MS analytical signal for chloroform (aqueous solution of 1 part per million (ppm), black squares—curve 37) and toluene (aqueous solution of 1 ppm, white squares—curve 38) with pumping time (flow rate=15-20 ml/min), Mark IV tubular MIMS sampler. At room temperature (about 22° C.) and 1 atmosphere pressure the analytical signal for chloroform reached equilibrium in 4-5 minutes.

FIG. 7

Graph showing the analytical cycle (solution introduction, followed by distilled water rinse—curve 39) for analyzing chloroform (1-ppm solution), flow rate=16 ml/min, quadrupole MS, Mark IV tubular MIMS sampler. At 10 minutes elapsed time, the 1-ppm solution was replaced by distilled water.

### OBJECTS AND ADVANTAGES

Increased exposure area to the analyte.

Minimization of sample dead-volume effects.

Heaters placed within the metal assembly allow for heating of the water that passes over the PDMS as dissolved gases and volatile organic compounds (VOC) are passed isothermally though the membrane into the vacuum chamber of a mass spectrometer (MS).

Rapid VOC response time.

Compact size and higher MS signal sensitivity.

The ability to perform MIMS with this geometry at high hydrostatic pressure without leaks.

The ability to hold the membrane shape regardless of the variation in, or absolute amount of, hydrostatic pressure applied.

An embodiment with a round vacuum housing is appropriate for perpendicular or cross-wise containment within the cylindrical external pressure housing of an underwater instrument, for example.

A method and apparatus for highly efficient dissolved gas and volatile organic compound transmittance from a fluid at pressures varying from atmosphere to full ocean depth equivalence of greater than 650 bars hydrostatic, or higher.

The flow-through tubing method is potentially 50 times more efficient than the flow-over tubing geometry.

Engineering challenges with delicate, small-diameter hollow fiber or tubing membrane designs at high hydrostatic pressures have been overcome by use of a hollow sintered metal tube that can in turn be surrounded by additional metal support.

The compressional fit a polymer membrane tubing over metal entrance and exit end assemblies of the tubing chamber that surrounds the hollow sintered metal tube located within the vacuum chamber prevents leakage of fluids under high hydrostatic pressure into the vacuum.

A contacting thermal pressure screw that allows heat transmittance to the hollow sintered metal tube and membrane allows for constant and higher temperatures to be applied during the MIMS analysis.

Provides for response times that are up to 5 times faster compared with previous flat (flow-over) and tubular (flow-through) geometry membrane units with similar inside diameters, analyte concentrations, and fluid flow rates.

### DETAILED DESCRIPTION AND OPERATION OF THE INVENTION

What is disclosed is a method and apparatus for obtaining highly efficient dissolved gas and volatile organic compound transmittance from a fluid at pressures varying from atmosphere to full ocean depth equivalence of greater than 650 bars hydrostatic, or higher. The flow-through tubing method is potentially 50 times more efficient than the flow-over tubing geometry previously used. The previous engineering challenges with such delicate, small-diameter hollow fiber or tubing membrane designs at high hydrostatic pressures have been overcome by use of a hollow sintered metal tube (stainless steel alloy, titanium alloy or the like) that can in turn be surrounded by additional metal support, if needed. Another advance is the ability to hold the membrane shape regardless of the variation in, or absolute amount of, hydrostatic pressure applied.

An important feature of the design is the compressional fit of the polymer membrane tubing 3 over the machined tubing adapters 29 connected to the sample inlet 24 and sample exit 25 tubes. These compression fittings are further inserted within the internal bore of the hollow sintered rod 4, providing a compression gasket between the polymer tubing and the tubing adapters. This gasket fit prevents leakage of fluids under high hydrostatic pressure into the vacuum chamber 23. An additional important feature is the contacting thermal pressure screw 28 that allows heat transmittance to this gas transmittance structure 34 comprised of the membrane surrounded by the hollow sintered rod within the vacuum chamber. This design allows for constant and higher temperatures to be applied during the MIMS analysis (e.g., LaPack et al., 1990).

As can be seen in the figures, this flow-through tubing design allows for a very compact MIMS assembly that can be located within the pressure housing of an underwater mass spectrometer instrument, as example. One preferred embodiment has size dimensions of only 1.83×3.70×1.05 inches (4.65×9.40×2.67 cm) leaving ample room for thermal insulation around the device so that low-powered, constant temperatures can be maintained. With the above embodiment example, the axis are defined as: x axis along the 3.7 inch length, y axis along the 1.83 inch length, and z axis along the 1.05 inch length.

For illustrative purposes, the inlet face of the box will be defined as the left side as viewed in FIGS. 2 and 3. The outlet face of the box will be defined as the right side as viewed in FIGS. 2 and 3. The thermal screw face of the box will be defined as the top side as viewed in FIGS. 2 and 3. The vacuum outlet face of the box will be defined as the bottom side as viewed in FIGS. 2 and 3. The heater face of the box will be defined as the front side as viewed in FIGS. 2 and 3.

A machined space with a circular cross section extends along the long x axis of this rectangular box centered on the central long axis of this box defined as the central location of the y and z plane. This rectangular box is metallic, preferably of stainless steel alloy, and is the body 30 of the apparatus. This machined space is of such diameter that it can be threaded to accept a predetermined, standard size Swagelok™ UltraTorr™ fitting body 14, on the inlet face of the body forming a component of the sample inlet port 10. Once threaded into the body, this Swagelok™ UltraTorr™ metallic fitting body, preferably of stainless steel alloy, is welded to the body and provides an ultra high vacuum seal with the body. The circular cross section of this opening continues a predetermined distance beyond the treads, defining a vacuum chamber 23 extending towards the outlet face. A circular cross section opening of predetermined diameter is machined along the y axis opening to the vacuum face. This opening is of a predetermined circular cross section and is centered on the z dimension at a predetermined location on the x axis. A thin wall metallic tube 22, preferably of stainless steel alloy, is closely fitted to this opening, providing a vacuum connection continuous with the vacuum chamber. This tube is attached by welding or epoxy cement, forming a high vacuum fitting.

The machined space along the x axis reduces in diameter to a predetermined dimension at a predetermined distance to the right of the threads at the inlet end. This diameter is such that it is closely spaced to the outer diameter of the contained gas transmittance structure 33 by a predetermined clearance. At a predetermined distance, the machined space along the x axis increases back to the original diameter of the circular cross section of the vacuum chamber. This machined space along the x axis maintains a circular cross section along it's entire length. Approximately midway along the length of reduced diameter machined space of the x axis, a circular cross section opening of predetermined diameter is machined along the y axis opening to the vacuum face. This opening of a predetermined circular cross section and is centered on the z dimension at a predetermined location on the x axis. It is threaded to accept thermal pressure screw 28. The diameter of this y axis bore, above the pressure screw, is increased and threaded and to accept the threads of a predetermined, standard size Swagelok™ VCR fitting body 14 forming a component of the thermal pressure screw port 13. Once threaded into the body, this Swagelok™ VCR metallic fitting, preferably of stainless steel alloy, is welded to the body and provides an ultra high vacuum seal with the body. The cap 15 of this Swagelok™ VCR fitting incorporates an O-ring 9 such that when the cap is properly threaded and tightened onto this Swagelok™ VCR fitting that the o-ring provides a high vacuum seal to the thermal pressure screw port on the box.

The thermal pressure screw is a metallic rod, preferably of stainless steel alloy, threaded to fit the threads of the opening extending towards the thermal screw face of the box. The portion of the thermal pressure screw that engages the gas transmittance structure is shaped, rounded, and polished as appropriate to apply pressure to this structure without damaging this structure as the screw turns within it's bore. The x axis face of the x axis machined space opposite the thermal screw bore is called the thermal contact area 27. Proper adjustment of the thermal pressure screw presses the gas transmittance structure against the thermal contact area providing for heat transmittance to the hollow gas transmittance structure contained therein from the metallic body. The end of the thermal pressure screw opposite the contact end is machined with an appropriately sized alien wrench fitting.

At a predetermined locations between the thermal contact area and the vacuum face are bored a predetermined number of circular openings extending from the heater face of the box along the z axis at predetermined x and y coordinates. These circular openings extend through the body to the opposite face. These are appropriately threaded to accept threaded electrical heating units 20 and thermistor temperature sensors 21.

The right most opening of the machined space along the x axis is threaded to accept a predetermined, standard size Swagelok™ VCR fitting forming a component of the assembly access port 12. Once threaded into the body, this Swagelok™ VCR metallic fitting body 14, preferably of stainless steel alloy, is welded to the body and provides an ultra high vacuum seal with the body. The cap 16 of this Swagelok™ VCR fitting cap with attached Swagelok™ UltraTorr™ fitting incorporates an O-ring 9 such that when this cap is properly threaded and tightened onto this Swagelok™ VCR fitting body 14 that the o-ring provides a high vacuum seal to the assembly access port on the body 30.

The machined space along the x axis contains a centrally located tubing assembly. It consist of a sample inlet tube 1, a sample exit tube 2, and centrally located gas transmittance structure 33. It consists of an inner tubular polymer membrane 3 surrounded by a hollow sintered rod 4. Very high pressure embodiments have this sintered rod enclosed within a pressure backing with drilled egress holes 5, usually metallic and most commonly stainless steel. This pressure backing provides further support against the hydrostatic pressure of the sample fluid. This preferably metal tube surrounds the sintered material and is in close contact with it. Tubes 24 and 25 are generally metallic, most commonly stainless steel.

Fluid is introduced through a tubular entrance 24 and exits through a tubular extension 25 on the opposite side of the vacuum chamber space, with fluid flowing from entrance to the exit. Within the gas transmittance structure, the sample fluid is no longer flowing within the confines of a tubing wall composed of the same composition of the inlet tube 24 and exit tube 25. There are four embodiments of this gas transmittance structure. In embodiment one, the wall of the tube consists of a thin preformed tubing wall 3 made of polymers such as poly dimethyl silicone (PDMS), Teflon™, or the like. This polymer tube is surrounded by a porous, sintered material shaped as a hollow sintered rod 4, preferably metallic and commonly stainless steel alloy. This hollow rod provides support against the applied pressure of the sample fluid. In embodiment two, this hollow sintered rod 4 of embodiment one is surrounded by a pressure backing with drilled egress holes 5, preferably metallic and commonly stainless steel alloy. In embodiment three, the thin preformed polymer tube is replaced by a thin, even coating, or a composite of coatings 3 on the inner wall of the hollow sintered rod 4. In embodiment four, the hollow sintered rod 4 of embodiment three is surrounded by a pressure backing with drilled egress holes 5, preferably metallic and commonly stainless steel alloy.

Dissolved gases and volatile organic compounds (VOCs) transfer into the vacuum through a thin, even coating, a composite of coatings, or preformed tubing walls 3 made of polymers such as poly dimethyl silicone (PDMS), Teflon™, or the like of the central most portion of the tubing assembly. The porous, sintered hollow rod 4 provides support against the applied pressure of the sample fluid. In high pressure applications, further support against hydrostatic pressure of the sample fluid is provided by the pressure backing with drilled egress holes 5 which is in close contact with the porous, sintered hollow rod. This structures provide for the ease of transmittance of the gases or VOC as molecular flow 6 into the surrounding vacuum chamber 23.

Embodiments one and two are preferred. Described following is further details of embodiment one. Embodiment two differs only with the addition of the pressure backing with drilled egress holes 5. Described is the assembly of the example embodiment of the 1.83×3.70×1.05 inch body described earlier.

The gas transmittance structure and associated apparatus consists of: a sample inlet tube 24, a sample outlet tube 25, two machined tubing adapters 29, a tubular polymer membrane 3, a hollow sintered rod 4, and a pressure baking with drilled holes 5, if used in a given application. In the given example the parts have the following approximate dimensions. Tubes 24, 25 are 0.085 inches inside diameter, 0.125 inches outside diameter and 4 or more inches long. Tubular polymer membrane 3 has an inside diameter of 0.070 inches and is 2 inches long. Hollow sintered rod 4 is 2 inches long with an outside diameter of 0.25 inches. Pressure baking with drilled holes 5, if used, is 2 inches long and an inside diameter of approximately 0.251 to 0.252 inches. Its outside diameter is appropriate for the application. Machined tubing adapter 29 is 0.45 inches long, generally with an outside diameter of 0.085 inches, and an inside diameter of 0.04 inches. An offset raised section 0.1 inches long extends to 0.25 inches in diameter and is located 0.2 inches from one end. Machined into that section are two groves evenly spaced 0.025 inches wide about 0.01 inches deep. The other end of the tubing adapter is inserted into one of the tubes and affixed in a pressure tight manner by welding.

The gas transmittance structure and associated apparatus is assembled in the following manner: The shorter ends of the machined tubing adapters are inserted into their corresponding tubes and affixed in a pressure tight manner by welding. One end of the tubular polymer membrane 3 is stretched over the longer end of one of the tubing adapters. Its elasticity allows it to tightly fit over this end of the adapter. It is stretched fully to abut with the 0.25 inch diameter section of the adapter. The loose end of the tubing is threaded through the hollow sintered rod 4 on a guide wire, not shown. It's elasticity allows it to be pulled from the far end of the sintered rod and stretched onto the other tubing adapter as done above. The tubing adapters are pressed into the end openings of the sintered rod. The clearance between the tubing and the inside bore of the sintered rod is such that a compression fitting is created between the tubing adapter and the tubular polymer membrane. The slope of the space between the groves machined on the tubing adapter is such that the adapter grabs and holds the tubular polymer membrane, making it difficult to remove this tubing. This combination provides a compression gasket between the polymer tubing and the tubing adapter. This gasket fit prevents leakage of fluids under high hydrostatic pressure into the vacuum chamber 23.

The active portion of the tubular membrane gas and volatile compounds sampler consist of the centrally located gas transmittance structure 33. It is sequentially arranged as a sample inlet tube, a gas transmittance structure, and a sample outlet tube. Once assembled, this structure is slid into the centrally machined x axis space of the apparatus body through the assembly access port 12. The inlet tube extends through the centrally located opening of the sample inlet port. The machined tubing adapter of the inlet tube abuts against this sample inlet port. A spacer of predetermined dimensions, not shown, is slipped over the outlet tube, abutting the machined tubing adapter of the outlet tube at one end and abutting the Swagelok™ VCR fitting cap with attached Swagelok™ UltraTorr™ fitting at the other end. This cap is appropriately threaded and tightened onto the Swagelok™ VCR fitting body of the assembly access port, compressing the o-ring forming a high vacuum seal. The Swagelok™ UltraTorr™ fitting caps, the Swagelok™ UltraTorr™ compression insert fitting, and o-rings are assembled, threaded, and appropriately tightened on their respective Swagelok™ UltraTorr™ fitting bodies. The inlet and outlet tubes are now vacuum sealed with the body of the apparatus. The thermal pressure screw 28 is inserted through the thermal pressure screw port 13, threaded, and appropriately tightened such that the gas transmittance structure 33 is pressed against thermal contact area 27. The Swagelok™ VCR fitting cap 15 of the thermal pressure screw port appropriately threaded and tightened onto the Swagelok™ VCR fitting body of the thermal pressure screw port, compressing the o-ring forming a high vacuum seal. The vacuum port 22 is appropriately attached, and sealed in a high vacuum manner, to it's associated vacuum apparatus. The contained vacuum chamber 23 is now contiguous and sealed with the attached vacuum apparatus in a vacuum tight manner. Mounting, electrical connections, inlet connections, and outlet connections complete assembly of the apparatus.

The gas transmittance structure and associated apparatus provide means for obtaining highly efficient dissolved gas and volatile organic compound transmittance from a fluid at pressures varying from atmosphere to full ocean depth equivalence of greater than 650 bars hydrostatic, or higher. This flow-through tubing design allows for a very compact MIMS assembly. High hydrostatic sample pressures can be reliably monitored by use of a hollow sintered metal tube that can in turn be surrounded by additional metal support, if needed. This also provides the ability to hold membrane shape regardless of the variation in, or absolute amount of, hydrostatic pressure applied. The flow-through tubing method is up to 50 times more efficient than the flow-over tubing geometry previously used. The compression fitting between the polymer tubing and the tubing adapters prevents leakage of fluids under high hydrostatic pressure into the vacuum chamber. The thermal pressure screw holding the gas transmittance structure in abutment with the thermal contact area provides for constant, efficient, and higher temperatures to be applied during the MIMS analysis. The small size of the apparatus provides ample room for thermal insulation around the device so that low-powered, constant temperatures can be maintained within compact instruments, such as within the pressure housing of an underwater mass spectrometer.

This apparatus functions by introducing a fluid sample into a section of tubing wherein the wall is not fully impermeable, but semipermeable to dissolved gases and volatile organic compounds. The portion of this wall abutting the sample fluid is composed of a thin, coating, or tubing composite of coatings of polymers such as poly dimethyl silicone (PDMS), Teflon™, or the like. Such structures are not able to resist the hydrostatic pressures of contained sample fluids without rupture and or leaking. A porous, sintered material provides initial support against the applied pressure of the fluid. In applications with very high sample fluid pressures further support against the hydrostatic pressure is provided by a metal tube, which surrounds the sintered material in close contact with it. This supporting tubing material has holes or slots drilled into it for ease of transmittance of the gases or VOC as molecular flow into the surrounding vacuum chamber. Heating of this gas transmittance structure provides increased efficiency and ease of transmittance of the gases or VOC. Small vacuum chamber size, resulting in low dead space, provides for faster and higher-pressure analytical response by a mass spectrometer or other analytical apparatus.

The improved sampler of dissolved gases and volatile organic compounds consist of: a body, a sample inlet port, a sample outlet port, an assembly port, a thermal pressure screw port, a vacuum port, a gas transmittance structure, a heater, and a thermistor.

The body includes: a machined open space free of structure comprising a vacuum chamber and a thermal contact area, two Swagelok™ VCR fitting bodies, one Swagelok™ UltraTorr™ fitting body, a vacuum port, a vacuum chamber, a machined space to accommodate a thermal pressure screw, two or more holes for attaching thermistors, heaters, and mounting apparatus. The body is a metallic structure, preferably stainless steel and provides a high vacuum seal for the vacuum chamber and vacuum port. The vacuum chamber and vacuum port are connected and contiguous with each other. The vacuum chamber consist of the free space of the machined open space of the body contiguous with the volumes of the: inlet port, outlet port, assembly port, thermal screw port, and the vacuum port minus the volume occupied by the bass transmittance structure, the gas transmittance structure spacer, and the thermal screw. The material of said body provides for high thermal energy transmission from heaters, thermistors, and said thermal contact area; wherein said machined open space provides a location for operation of a gas transmittance structure.

The sample inlet port includes: one Swagelok™ UltraTorr™ fitting body, one Swagelok™ UltraTorr™ fitting cap, one Swagelok™ UltraTorr™ compression insert fitting, and one o-ring. The Swagelok™ UltraTorr™ fitting body is threaded into the body of the apparatus and the Swagelok™ UltraTorr™ fitting body is welded to the body of the apparatus forming a high vacuum seal. Upon insertion of the gas transmittance structure with it's inlet and outlet tubes, that the inlet tube extends through the central opening of the Swagelok™ UltraTorr™ fitting body. The o-ring and the Swagelok™ UltraTorr™ compression insert fitting are placed over the inlet tube, properly inserted into the Swagelok™ UltraTorr™ fitting body. The Swagelok™ UltraTorr™ fitting cap is properly aligned, slipped over the inlet tube and properly threaded and tightened onto the Swagelok™ UltraTorr™ fitting body. This compresses the o-ring between the outer surface of the inlet tube and the machined recess of the Swagelok™ UltraTorr™ fitting body providing a vacuum seal between the inlet tube and the Swagelok™ UltraTorr™ fitting body. This provides for exit of the inlet tube from the body of the apparatus while maintaining a high vacuum seal for the vacuum chamber contained within the body of the apparatus.

The sample outlet port includes: one Swagelok™ UltraTorr™ fitting body, one Swagelok™ UltraTorr™ fitting cap, one Swagelok™ UltraTorr™ compression insert fitting, and one o-ring. The Swagelok™ UltraTorr™ fitting body is threaded into a machined and threaded opening centered in the Swagelok™ VCR fitting cap of the assembly port; wherein the Swagelok™ UltraTorr™ fitting body is welded to the Swagelok™ VCR fitting cap of the assembly port forming a high vacuum seal. Upon insertion of the gas transmittance structure with it's inlet and outlet tubes, the outlet tube extends through the central opening of the Swagelok™ UltraTorr™ fitting body. The o-ring and the Swagelok™ UltraTorr™ compression insert fitting are placed over the outlet tube and properly inserted into the Swagelok™ UltraTorr™ fitting body. The Swagelok™ UltraTorr™ fitting cap is properly aligned, slipped over the outlet tube and properly threaded and tightened onto the Swagelok™ UltraTorr™ fitting body. This compresses the o-ring between the outer surface of the inlet tube and the machined recess of the Swagelok™ UltraTorr™ fitting body providing a vacuum seal between the outlet tube and the Swagelok™ UltraTorr™ fitting body. This provides for exit of the outlet tube the Swagelok™ VCR fitting cap of the assembly port while maintaining a high vacuum seal between the outlet tube and the Swagelok™ VCR fitting cap of the assembly port. With this Swagelok™ VCR fitting cap of the assembly port appropriately threaded and tightened onto the Swagelok™ VCR fitting body of the assembly port, such assembly provides for exit of the outlet tube from the body of the apparatus while maintaining a high vacuum seal for the vacuum chamber contained within the body of the apparatus.

The assembly port includes: one Swagelok™ VCR metallic fitting body, one Swagelok™ VCR fitting cap, one Swagelok™ UltraTorr™ fitting body, one Swagelok™ UltraTorr™ fitting cap, one Swagelok™ UltraTorr™ compression insert fitting, and two o-rings. The Swagelok™ VCR metallic fitting body is threaded into the body of the apparatus and the Swagelok™ VCR metallic fitting body is welded to the body of the apparatus forming a high vacuum seal. The Swagelok™ UltraTorr™ fitting body is threaded into a machined and threaded opening centered in the Swagelok™ VCR fitting cap of this assembly port and the Swagelok™ UltraTorr™ fitting body is welded to the Swagelok™ VCR fitting cap of this assembly port. This forms a high vacuum seal between the Swagelok™ VCR fitting cap of this assembly port and said Swagelok™ UltraTorr™ fitting body.

Upon assembly of the apparatus, the gas transmittance structure with it's inlet and outlet tubes, is inserted through the central opening of the Swagelok™ VCR metallic fitting body welded to the body of the apparatus with an orientation such that the inlet tube of the structure passes through the central machined space of the body and extends through the central opening of the inlet port with the structure. It is inserted until the inlet end of the gas transmittance structure securely abuts the internal structure of the inlet port and the machined spacer is slipped down the exit tube until it securely abuts the outlet end of the gas transmittance structure.

The assembly port and it's integral exit port are assembled in the following sequence: The assembly port o-ring is placed over the outlet tube and properly positioned within the groove of the Swagelok™ VCR metallic fitting body. The Swagelok™ VCR fitting cap of this assembly port is properly aligned, slipped over the outlet tube such that the outlet tube extends through the attached outlet port. The Swagelok™ VCR fitting cap of this assembly port is properly threaded and tightened onto the Swagelok™ VCR metallic fitting body of this assembly port. This compresses the o-ring between the inner surface of the Swagelok™ VCR fitting cap of this assembly port with it's attached outlet port and the machined surfaces of the Swagelok™ VCR metallic fitting body of this assembly port. This provides a vacuum seal between the outlet port attached to the Swagelok™ VCR fitting cap and the Swagelok™ UltraTorr™ fitting body welded in a vacuum tight manner to the body of the apparatus. Upon tightening said Swagelok™ VCR fitting cap properly on the Swagelok™ VCR metallic fitting body of this assembly port brings the spacer installed on the outlet tube to predetermined abutment with the inside of the Swagelok™ VCR fitting cap. This provides for rigidly holding said gas transmittance structure along the x axis of the machined internal space of the body of the apparatus with it's outlet with it's outlet tube extending out through the central opening of the outlet port. The assembly port is then completed in assembly by the assembling of it's attached outlet in the following sequence: wherein the o-ring and the Swagelok™ UltraTorr™ compression insert fitting are placed over the outlet tube, properly inserted into the Swagelok™ UltraTorr™ fitting body. The Swagelok™ UltraTorr™ fitting cap is properly aligned, slipped over the outlet tube and properly threaded and tightened onto the Swagelok™ UltraTorr™ fitting body. This compresses the o-ring between the outer surface of the inlet tube and the machined recess of the Swagelok™ UltraTorr™ fitting body providing a vacuum seal between the outlet tube and the Swagelok™ UltraTorr™ fitting body. This provides for exit of the outlet tube the Swagelok™ VCR fitting cap of the assembly port while maintaining a high vacuum seal between the outlet tube and the Swagelok™ VCR fitting cap of the assembly port; wherein with this Swagelok™ VCR fitting cap of the assembly port appropriately threaded and tightened onto the Swagelok™ VCR fitting body of the assembly port. Such assembly provides for exit of the outlet tube from the body of the apparatus while maintaining a high vacuum seal for the vacuum chamber contained within the body of the apparatus.

The thermal pressure screw port includes: one Swagelok™ VCR metallic fitting body, one Swagelok™ VCR fitting cap, one o-ring, and one thermal pressure screw. The Swagelok™ VCR metallic fitting body is threaded into the body of the apparatus and the Swagelok™ VCR metallic fitting body is welded to the body of the apparatus forming a high vacuum seal. Upon assembly of the apparatus, the gas transmittance structure with it's inlet and outlet tubes and spacer is inserted into the apparatus in a predetermined manner. The assembly port and it's integral outlet port are assembled in a predetermined manner providing a high vacuum tight seal between the outer surface of the outlet tube and the body of the apparatus. The inlet port is assembled in a predetermined manner providing a high vacuum tight seal between the outer surface of the inlet tube and the body of the apparatus. The thermal pressure screw port is assembled in the following sequence: The thermal pressure screw is properly aligned, inserted, and threaded in it's bore within the thermal pressure screw port. The thermal pressure screw is properly adjusted to abut the gas transmittance structure such that said gas transmittance structure is pushed into abutment with the thermal contact area of the machined internal space of the body of the apparatus. The o-ring is properly positioned within the groove of the Swagelok™ VCR metallic fitting body and the Swagelok™ VCR fitting cap of this thermal pressure screw port is properly aligned threaded and tightened onto the Swagelok™ VCR metallic fitting body of this thermal pressure screw port. This assembly compresses the o-ring between the inner surface of the Swagelok™ VCR fitting cap of this thermal pressure screw and the machined surfaces of the Swagelok™ VCR metallic fitting body of this thermal pressure screw port providing a vacuum seal between the Swagelok™ VCR fitting cap and the Swagelok™ UltraTorr™ fitting body welded in a vacuum tight manner to the body of the apparatus. Such assembly provides for the insertion and adjustment of the thermal pressure screw into the body of the apparatus while maintaining a high vacuum seal for the vacuum chamber contained within the body of the apparatus. After insertion of the gas transmittance structure, the subsequent assembly of the assembly port, outlet port, inlet port, and thermal pressure screw port provide for a high vacuum sealed chamber contiguous with the vacuum port which is sealed in a high vacuum manner from the inlet and outlet tubes exiting the body.

The vacuum space includes a machined circular opening extending from the vacuum face and connecting with the machined open space aligned on the x axis of the body and a vacuum connection tube. The vacuum connection tube is a metallic tube that is fitted into the machined circular opening and fastened in a vacuum tight manner by welding or epoxy cement. This provides a vacuum tight connection with the enclosed vacuum chamber. The resulting small vacuum chamber size, resulting in low dead space, provides for faster and higher-pressure analytical response by a mass spectrometer or other analytical apparatus.

The gas transmittance structure is a component of a gas transmittance assembly comprised of: an inlet tube, an outlet tube, a spacer, and the centrally located gas transmittance structure. The gas transmittance structure is comprised of: two machined tubing adapters, a membrane tube, a hollow sintered rod, and in some applications a metallic pressure backing tube. The gas transmittance structure is assembled by the following steps: The shorter ends of the machined tubing adapters are inserted into their corresponding tubes and affixed in a pressure tight manner by welding. One end of the tubular polymer membrane is stretched over the longer end of one of the tubing adapters with its elasticity allowing it to tightly fit over this end of the adapter and it is stretched to fully abut with the increased diameter section of the adapter. The loose end of the tubing is threaded through the hollow sintered rod on a guide wire with it's elasticity allowing it to be pulled from the far end of the sintered rod and stretched onto the other tubing adapter as done above. The tubing adapters are pressed into the end openings of the sintered rod. This assembly results that the clearance between the tubing and the inside bore of the sintered rod is such that a compression fitting is created between the tubing adapter and the tubular polymer membrane with the slope of the space between the groves machined on the tubing adapter is such that the adapter grabs and holds the tubular polymer membrane, making it difficult to remove this tubing. This combination provides a compression gasket between the polymer tubing and the tubing adapter such that this gasket fit prevents leakage of fluids under high hydrostatic pressure into the vacuum chamber. This gas transmittance structure provide means for obtaining highly efficient dissolved gas and volatile organic compound transmittance from a fluid at pressures varying from atmosphere to full ocean depth equivalence of greater than 650 bars hydrostatic, or higher. This ow-through tubing design allows for a very compact membrane introduction mass spectrometry assembly. This gas transmittance structure functions by introducing a fluid sample into a section of tubing wherein the wall is not fully impermeable, but semipermeable to dissolved gases and volatile organic compounds. The portion of this wall abutting the sample fluid is composed of a thin, coating, or tubing composite of coatings of polymers such as poly dimethyl silicone (PDMS), Teflon™, or the like. A porous, sintered material provides initial support against the applied pressure of the fluid. In applications with very high sample fluid pressures, further support against the hydrostatic pressure is provided by a metal tube, which surrounds the sintered material in close contact with it in which this supporting tubing material has holes or slots drilled into it for ease of transmittance of the gases or volatile organic compounds as molecular flow into the surrounding vacuum chamber. Heating of this gas transmittance structure provides increased efficiency and ease of transmittance of the gases or volatile organic compounds.

The heater consists of one or more electric heaters fixedly mounted within holes machined within the body of the apparatus in close proximity to the of the thermal contact area. They provide or heat transmittance to the hollow sintered metal tube and membrane. This provides for constant and higher temperatures to be applied during the membrane introduction mass spectrometry analysis. This provides for more efficient and controlled transmittance of gases and volatile organic compounds as molecular flow into the surrounding vacuum chamber.

The thermistor consists of one or more electric thermistors fixedly mounted within holes machined within the body of the apparatus in close proximity to the of the thermal contact area. This provides or heat regulation by feedback control of electric circuits controlling the heaters. Such provides a constant, controlled elevated temperature of the hollow sintered metal tube and membrane during the membrane introduction mass spectrometry analysis. This provides for more efficient and controlled transmittance of gases and volatile organic compounds as molecular flow into the surrounding vacuum chamber.

The apparatus and operation of this improved compact, tubular, high transmittance sampler of dissolved gases and volatile organic compounds provide improved means of gas sampler operation including: A means of providing a flow-through tubing method that is upwards of up to 50 times more efficient than flow-over tubing geometry. A means of providing pressure backing to thin membranes by using a use of a hollow sintered metal or ceramic tube surrounding the membrane. A means of providing further pressure support by surrounding the hollow sintered tube with a metal tube with openings provides for gas and volatile organic compound egress. A means providing the membrane to hold shape regardless of the variation in, or absolute amount of, hydrostatic pressure applied. A means of providing a compression gasket between the polymer tubing and the tubing adapters wherein this gasket fit prevents leakage of fluids under high hydrostatic pressure into the vacuum chamber. A means of allowing heat transmittance to the gas transmittance structure comprised of the membrane surrounded by the hollow sintered rod within the vacuum chamber. A means for providing for constant and higher temperatures to be applied during the membrane introduction mass spectrometry analysis. A means of providing a very compact membrane introduction mass spectrometry assembly that can be located within the pressure housing of an underwater mass spectrometer instrument. A means providing for ample room for thermal insulation around the device so that low-powered, constant temperatures can be maintained within compact instruments. A means of providing a small vacuum chamber size resulting in low dead space. A means providing for faster and higher-pressure analytical response by a mass spectrometer or other analytical apparatus. A means of performing membrane introduction mass spectrometry analysis at high hydrostatic pressure without fluid leaks into the vacuum space or the instrument space. A means wherein a pressure supporting tube surrounds the hollow sintered metal or ceramic tube surrounding the membrane provides for increased pressure support for performing membrane introduction mass spectrometry analysis at high hydrostatic pressure without fluid leaks. A means wherein a pressure supporting tube has drilled holes which provide for the ease of transmittance of the gases or volatile organic compounds as molecular flow into the surrounding vacuum chamber. A means wherein a pressure supporting tube has machined slots which provide for the ease of transmittance of the gases or volatile organic compounds as molecular flow into the surrounding vacuum chamber. A means wherein the compact size of a membrane introduction mass spectrometry analysis unit leaves ample room for thermal insulation around the device so that low-powered, constant temperatures can be maintained in instruments where space and power are limited. A means wherein a thermal pressure screw maintains abutment and close contact of the gas transmittance structure with the thermal contact area providing efficient heat transfer from the body of the apparatus to said gas transmittance structure providing for low power operation. A means in which an exposed gas transmittance structure is mounted within a round vacuum chamber endcap providing for direct exposure with the vacuum of said vacuum chamber. A means in which coiled inlet and outlet tubing permit removal of the gas transmittance structure from a round vacuum chamber endcap providing for change-out of the membrane. A means whereby a heater block mounted on the outside of round vacuum chamber endcap provides for membrane introduction mass spectrometry analysis at high, constant temperatures.

### CONCLUSION, RAMIFICATIONS, AND SCOPE

This tubular membrane gas and volatile compounds sampler provides for a compact, efficient apparatus for use in instruments where space and available electrical power are at a premium such as underwater mass spectrometers. One preferred embodiment has size dimensions of only 1.83×3.70×1.05 inches (4.65×9.40×2.67 cm) leaving ample room for thermal insulation around the device so that low-powered, constant temperatures can be maintained. Four embodiments of the active gas transmittance structure provide flexibility to configure the unit to best suit the nature of the sample fluid, the expected nature of the dissolved gases or VOC, and the operating pressures encountered. Controlled temperature heating provides for improved and controlled transmittance performance of gases or VOC. Small vacuum chamber size, resulting in low dead space, provides for faster and higher-pressure analytical response by a mass spectrometer or other analytical apparatus.

In the descriptions above, we have put forth theories of operation that we believe to be correct, such as the manner of gas and VOC transmittance. While we believe these theories to be correct, we don't wish to be bound by them. While there have been described above the principals of this invention in connection with specific apparatus, it is to be clearly understood that this description is made only by way of example and is not as a limitation to the scope of the invention. Other embodiments of these approaches to efficient dissolved gas and volatile organic compound transmittance from a fluid will be apparent to those skilled in the art from consideration of the specification and practice of the invention disclosed herein. It is intended that the specification be considered as exemplary only, with the true scope and spirit of the invention being indicated by the appended claims and their legal equivalents, rather than by the examples given.

We claim:

1. An improved apparatus of a compact, tubular, high transmittance sampler of dissolved gases and volatile organic compounds for efficiently obtaining dissolved gas and volatile organic compound transmittance and collection from a fluid at pressures varying from atmosphere to full ocean depth equivalence, of greater than 650 bars hydrostatic, wherein transmittance is through a small-diameter membrane wherein the composition of said small-diameter membrane is selected from the group consisting of:
1) a small-diameter hollow fiber membrane,
2) a tubing membrane,
3) a thin even coating of predetermined materials,
4) a thin even composite coating,
5) preformed tubing of a predetermined material,
6) preformed tubing of a composite of predetermined materials,
7) or a mixture thereof;
wherein said membrane is located within a hollow sintered tubular material wherein said sintered tubular material is composed of one or more materials selected from the group consisting of:
1) ceramic,
2) stainless steel alloy metal,
3) titanium alloy metal,
4) a predetermined metal alloy,
5) or a mixture thereof;
wherein said sintered tubular material provides pressure support permitting the membrane to withstand the hydrostatic pressure of the contained sample; wherein with applications with very high sample pressures, said hollow sintered tubular material can be in turn surrounded by a metallic tube providing additional pressure support, wherein said metallic tube has one or more means of gas or VOC egress selected from the group consisting of:
1) drilled holes,
2) machined slots,
3) or a mixture thereof;
wherein these means provide for ease of transmittance of gases or VOC's as molecular flow into the surrounding vacuum chamber.

2. An improved means of sampling dissolved gases and volatile organic compounds with a compact, tubular, high transmittance sampler providing for efficiently obtaining dissolved gas and volatile organic compound transmittance and collection from a fluid at pressures varying from atmosphere to full ocean depth equivalence, of greater than 650 bars hydrostatic, wherein transmittance is through a small-diameter membrane wherein the composition of said small-diameter membrane is selected from the group consisting of:
1) a small-diameter hollow fiber membrane,
2) a tubing membrane,
3) a thin even coating of predetermined materials,
4) a thin even composite coating,
5) preformed tubing of a predetermined material,
6) preformed tubing of a composite of predetermined materials,
7) or a mixture thereof;
wherein said membrane is located within a hollow sintered tubular material wherein said sintered tubular material is composed of one or more materials selected from the group consisting of:
1) ceramic,
2) stainless steel alloy metal,
3) titanium alloy metal,
4) a predetermined metal alloy,
5) or a mixture thereof;
wherein said sintered tubular material provides pressure support permitting the membrane to withstand the hydrostatic pressure of the contained sample; wherein with applications with very high sample pressures, said hollow sintered tubular material can be in turn surrounded by a metallic tube providing additional pressure support, wherein said metallic tube has one or more means of gas or VOC egress selected from the group consisting of:
1) drilled holes,
2) machined slots,
3) or a mixture thereof;
wherein these means provide for ease of transmittance of gases or VOC's as molecular flow into the surrounding vacuum chamber.

3. The improved sampler of dissolved gases and volatile organic compounds of claim 1 wherein said improved sampler of dissolved gases and volatile organic compounds provides for one or more improvements selected from the group consisting of:
1) increased exposure area to the analyte for a given instrument size,
2) minimization of sample dead-volume effects,
3) rapid volatile organic compounds response time,
4) compact size,
5) higher mass spectrometer sensitivity,
6) the ability to perform membrane introduction mass spectrometry with this geometry at high hydrostatic pressure without leaks,
8) the ability to hold the membrane shape regardless of the variation in, or absolute amount of, hydrostatic pressure applied,
9) highly efficient dissolved gas and volatile organic compound transmittance from a fluid at pressures varying from atmosphere to full ocean depth equivalence of greater than 650 bars hydrostatic, or higher,
10) response times that are up to 5 times faster compared with previous flat (flow-over) and tubular (flow-through) geometry membrane units,
11) or a mixture thereof.

4. The improved sampler of dissolved gases and volatile organic compounds of claim 1 wherein said improved sampler of dissolved gases and volatile organic compounds consist of a body, a sample inlet port, a sample outlet port, an assembly port, a thermal pressure screw port, a vacuum port, a gas transmittance structure, a heater, and a thermistor.

5. The body of claim 4 wherein said body includes: a machined open space free of structure comprising a vacuum chamber and a thermal contact area, two Swagelok™ VCR fitting bodies, one Swagelok™ UltraTorr™ fitting body, a vacuum port, a vacuum chamber, a machined space to accommodate a thermal pressure screw, two or more holes for attaching thermistors, heaters, and mounting apparatus; and wherein said body is a metallic structure, preferably stainless steel; wherein said vacuum chamber and vacuum port are connected and contiguous with each other; wherein said body provides a high vacuum seal for the vacuum chamber and vacuum port; wherein said vacuum chamber consist of the free space of the machined open space of the body contiguous with the volumes of the: inlet port, outlet port, assembly port, thermal screw port, and the vacuum port minus the volume occupied by the bass transmittance structure, the gas transmittance structure spacer, and the thermal screw; wherein the material of said body provides for high thermal energy transmission from heaters, thermistors, and said thermal contact area; wherein said machined open space provides a location for operation of a gas transmittance structure.

6. The sample inlet port of claim 4 wherein said sample inlet port includes: one Swagelok™ UltraTorr™ fitting body, one Swagelok™ UltraTorr™ fitting cap, one Swagelok™ UltraTorr™ compression insert fitting, and one o-ring; wherein the Swagelok™ UltraTorr™ fitting body is threaded into the body of the apparatus; wherein the Swagelok™ UltraTorr™ fitting body is welded to the body of the apparatus forming a high vacuum seal; wherein upon insertion of the gas transmittance structure with it's inlet and outlet tubes, that the inlet tube extends through the central opening of the Swagelok™ UltraTorr™ fitting body; wherein the o-ring and the Swagelok™ UltraTorr™ compression insert fitting are placed over the inlet tube, properly inserted into the Swagelok™ UltraTorr™ fitting body; wherein the Swagelok™ UltraTorr™ fitting cap is properly aligned, slipped over the inlet tube and properly threaded and tightened onto the Swagelok™ UltraTorr™ fitting body; wherein this compresses the o-ring between the outer surface of the inlet tube and the machined recess of the Swagelok™ UltraTorr™ fitting body providing a vacuum seal between the inlet tube and the Swagelok™ UltraTorr™ fitting body; wherein this provides for exit of the inlet tube from the body of the apparatus while maintaining a high vacuum seal for the vacuum chamber contained within the body of the apparatus.

7. The sample outlet port of claim 4 wherein said sample outlet port includes: one Swagelok™ UltraTorr™ fitting body, one Swagelok™ UltraTorr™ fitting cap, one Swagelok™ UltraTorr™ compression insert fitting, and one o-ring; wherein the Swagelok™ UltraTorr™ fitting body is threaded into a machined and threaded opening centered in the Swagelok™ VCR fitting cap of the assembly port; wherein the Swagelok™ UltraTorr™ fitting body is welded to the Swagelok™ VCR fitting cap of the assembly port forming a high vacuum seal; wherein upon insertion of the gas transmittance structure with it's inlet and outlet tubes, that the outlet tube extends through the central opening of the Swagelok™ UltraTorr™ fitting body; wherein the o-ring and the Swagelok™ UltraTorr™ compression insert fitting are placed over the outlet tube, properly inserted into the Swagelok™ UltraTorr™ fitting body; wherein the Swagelok™ UltraTorr™ fitting cap is properly aligned, slipped over the outlet tube and properly threaded and tightened onto the Swagelok™ UltraTorr™ fitting body; wherein this compresses the o-ring between the outer surface of the inlet tube and the machined recess of the Swagelok™ UltraTorr™ fitting body providing a vacuum seal between the outlet tube and the Swagelok™ UltraTorr™ fitting body; wherein this provides for exit of the outlet tube the Swagelok™ VCR fitting cap of the assembly port while maintaining a high vacuum seal between the outlet tube and the Swagelok™ VCR fitting cap of the assembly port; wherein with this Swagelok™ VCR fitting cap of the assembly port appropriately threaded and tightened onto the Swagelok™ VCR fitting body of the assembly port, such assembly provides for exit of the outlet tube from the body of the apparatus while maintaining a high vacuum seal for the vacuum chamber contained within the body of the apparatus.

8. The assembly port of claim 4 wherein said assembly port includes: one Swagelok™ VCR metallic fitting body, one Swagelok™ VCR fitting cap, one Swagelok™ UltraTorr™ fitting body, one Swagelok™ UltraTorr™ fitting cap, one Swagelok™ UltraTorr™ compression insert fitting, and two o-rings; wherein the Swagelok™ VCR metallic fitting body is threaded into the body of the apparatus; wherein the Swagelok™ VCR metallic fitting body is welded to the body of the apparatus forming a high vacuum seal; wherein the Swagelok™ UltraTorr™ fitting body is threaded into a machined and threaded opening centered in the Swagelok™ VCR fitting cap of this assembly port; wherein the Swagelok™ UltraTorr™ fitting body is welded to the Swagelok™ VCR fitting cap of this assembly port forming a high vacuum seal between the Swagelok™ VCR fitting cap of this assembly port and said Swagelok™ UltraTorr™ fitting body; wherein upon assembly of the apparatus, the gas transmittance structure with it's inlet and outlet tubes, is inserted through the central opening of the Swagelok™ VCR metallic fitting body welded to the body of the apparatus with an orientation such that the inlet tube of the structure passes through the central machined space of the body and extends through the central opening of the inlet port with the structure, and it is inserted until the inlet end of the gas transmittance structure securely abuts the internal structure of the inlet port, wherein the machined spacer is slipped down the exit tube until it securely abuts the outlet end of the gas transmittance structure, wherein the assembly port and it's integral exit port are assembled in the following sequence: the assembly port o-ring is placed over the outlet tube and properly positioned within the groove of the Swagelok™ VCR metallic fitting body, the Swagelok™ VCR fitting cap of this assembly port is properly aligned, slipped over the outlet tube such that the outlet tube extends through the attached outlet port, and the Swagelok™ VCR fitting cap of this assembly port is properly threaded and tightened onto the Swagelok™ VCR metallic fitting body of this assembly port; wherein this compresses the o-ring between the inner surface of the Swagelok™ VCR fitting cap of this assembly port with it's attached outlet port and the machined surfaces of the Swagelok™ VCR metallic fitting body of this assembly port providing a vacuum seal between the outlet port attached to the Swagelok™ VCR fitting cap and the Swagelok™ UltraTorr™ fitting body welded in a vacuum tight manner to the body of the apparatus, wherein upon tightening said Swagelok™ VCR fitting cap properly on the Swagelok™ VCR metallic fitting body of this assembly port brings the spacer installed on the outlet tube to predetermined abutment with the inside of the Swagelok™ VCR fitting cap providing for rigidly holding said gas transmittance structure along the x axis of the machined internal space of the body of the apparatus with it's outlet with it's outlet tube extending out through the central opening of the outlet port; wherein the assembly port is completed in assembly by the assembling of it's attached outlet in the following sequence: wherein the o-ring and the Swagelok™ UltraTorr™ compression insert fitting are placed over the outlet tube, properly inserted into the Swagelok™ UltraTorr™ fitting body; wherein the Swagelok™ UltraTorr™ fitting cap is properly aligned, slipped over the outlet tube and properly threaded and tightened onto the Swagelok™ UltraTorr™ fitting body; wherein this compresses the o-ring between the outer surface of the inlet tube and the machined recess of the Swagelok™ UltraTorr™ fitting body providing a vacuum seal between the outlet tube and the Swagelok™ UltraTorr™ fitting body; wherein this provides for exit of the outlet tube the Swagelok™ VCR fitting cap of the assembly port while maintaining a high vacuum seal between the outlet tube and the Swagelok™ VCR fitting cap of the assembly port; wherein with this Swagelok™ VCR fitting cap of the assembly port appropriately threaded and tightened onto the Swagelok™ VCR fitting body of the assembly port, such assembly provides for exit of the outlet tube from the body of the apparatus while maintaining a high vacuum seal for the vacuum chamber contained within the body of the apparatus.

9. The thermal pressure screw port of claim 4 wherein said thermal pressure screw port includes: one Swagelok™ VCR metallic fitting body, one Swagelok™ VCR fitting cap, one o-ring, and one thermal pressure screw; wherein the Swagelok™ VCR metallic fitting body is threaded into the body of the apparatus; wherein the Swagelok™ VCR metallic fitting body is welded to the body of the apparatus forming a high vacuum seal; wherein upon assembly of the apparatus, the gas transmittance structure with it's inlet and outlet tubes and spacer is inserted into the apparatus in a predetermined manner; wherein the assembly port and it's integral outlet port are assembled in a predetermined manner providing a high vacuum tight seal between the outer surface of the outlet tube and the body of the apparatus; wherein the inlet port is assembled in a predetermined manner providing a high vacuum tight seal between the outer surface of the inlet tube and the body of the apparatus; wherein the thermal pressure screw port is assembled in the following sequence: the thermal pressure screw is properly aligned, inserted, and threaded in it's bore within the thermal pressure screw port, the thermal pressure screw is properly adjusted to abut the gas transmittance structure such that said gas transmittance structure is pushed into abutment with the thermal contact area of the machined internal space of the body of the apparatus, the o-ring is properly positioned within the groove of the Swagelok™ VCR metallic fitting body, the Swagelok™ VCR fitting cap of this thermal pressure screw port is properly aligned threaded and tightened onto the Swagelok™ VCR metallic fitting body of this thermal pressure screw port; wherein this compresses the o-ring between the inner surface of the Swagelok™ VCR fitting cap of this thermal pressure screw and the machined surfaces of the Swagelok™ VCR metallic fitting body of this thermal pressure screw port providing a vacuum seal between the Swagelok™ VCR fitting cap and the Swagelok™ UltraTorr™ fitting body welded in a vacuum tight manner to the body of the apparatus; wherein such assembly provides for the insertion and adjustment of the thermal pressure screw into the body of the apparatus while maintaining a high vacuum seal for the vacuum chamber contained within the body of the apparatus; wherein after insertion of the gas transmittance structure, the subsequent assembly of the assembly port, outlet port, inlet port, and thermal pressure screw port provide for a high vacuum sealed chamber contiguous with the vacuum port which is sealed in a high vacuum manner from the inlet and outlet tubes exiting the body.

10. The vacuum space of claim 4 wherein said vacuum space includes: a machined circular opening extending from the vacuum face and connecting with the machined open space aligned on the x axis of the body, a vacuum connection tube; wherein said vacuum connection tube is a metallic tube that is fitted into said machined circular opening and fastened in a vacuum tight manner by welding or epoxy cement providing a vacuum tight connection with the enclosed vacuum chamber; wherein the resulting small vacuum chamber size, resulting in low dead space, provides for faster and higher-pressure analytical response by a mass spectrometer or other analytical apparatus.

11. The gas transmittance structure of claim 4 wherein said gas transmittance structure is a component of a gas transmittance assembly comprised of: an inlet tube, an outlet tube, a spacer, and the centrally located gas transmittance structure; wherein said gas transmittance structure is comprised of: two machined tubing adapters, a membrane tube, a hollow sintered rod, and in some applications a metallic pressure backing tube; wherein said gas transmittance structure is assembled by the following steps: the shorter ends of the machined tubing adapters are inserted into their corresponding tubes and affixed in a pressure tight manner by welding, one end of the tubular polymer membrane is stretched over the longer end of one of the tubing adapters with its elasticity allowing it to tightly fit over this end of the adapter and it is stretched to fully abut with the increased diameter section of the adapter, the loose end of the tubing is threaded through the hollow sintered rod on a guide wire with it's elasticity allowing it to be pulled from the far end of the sintered rod and stretched onto the other tubing adapter as done above, and the tubing adapters are pressed into the end openings of the sintered rod; wherein this assembly results that the clearance between the tubing and the inside bore of the sintered rod is such that a compression fitting is created between the tubing adapter and the tubular polymer membrane with the slope of the space between the groves machined on the tubing adapter is such that the adapter grabs and holds the tubular polymer membrane, making it difficult to remove this tubing; wherein this combination provides a compression gasket between the polymer tubing and the tubing adapter such that this gasket fit prevents leakage of fluids under high hydrostatic pressure into the vacuum chamber; wherein this gas transmittance structure provide means for obtaining highly efficient dissolved gas and volatile organic compound transmittance from a fluid at pressures varying from atmosphere to full ocean depth equivalence of greater than 650 bars hydrostatic, or higher; wherein this flow-through tubing design allows for a very compact membrane introduction mass spectrometry assembly; wherein said gas transmittance structure functions by introducing a fluid sample into a section of tubing wherein the wall is not fully impermeable, but semipermeable to dissolved gases and volatile organic compounds with the portion of this wall abutting the sample fluid is composed of a thin, coating, or tubing composite of coatings of polymers such as poly dimethyl silicone (PDMS), Teflon™, or the like wherein a porous, sintered material provides initial support against the applied pressure of the fluid and in applications with very high sample fluid pressures further support against the hydrostatic pressure is provided by a metal tube, which surrounds the sintered material in close contact with it in which this supporting tubing material has holes or slots drilled into it for ease of transmittance of the gases or volatile organic compounds as molecular flow into the surrounding vacuum chamber; whereby heating of this gas transmittance structure provides increased efficiency and ease of transmittance of the gases or volatile organic compounds.

12. The heater of claim 4 wherein said heater consists of one or more electric heaters fixedly mounted within holes machined within the body of the apparatus in close proximity to the of the thermal contact area providing for heat transmittance to the hollow sintered metal tube and membrane which provides for constant and higher temperatures to be applied during the membrane introduction mass spectrometry analysis which provides for more efficient and controlled transmittance of gases and volatile organic compounds as molecular flow into the surrounding vacuum chamber.

13. The thermistor of claim 4 wherein said thermistor consists of one or more electric thermistors fixedly mounted within holes machined within the body of the apparatus in close proximity to the of the thermal contact area providing for heat regulation by feedback control of electric circuits controlling the heaters whereby such operation provides a constant, controlled elevated temperature of the hollow sintered metal tube and membrane during the membrane introduction mass spectrometry analysis which provides for more efficient and controlled transmittance of gases and volatile organic compounds as molecular flow into the surrounding vacuum chamber.

14. The improved means of sampling dissolved gases and volatile organic compounds of claim 2 wherein said improved means of sampling dissolved gases and volatile organic compounds include one or more improved means selected from the group consisting of:
1) a means providing a flow-through tubing method that is upwards of up to 50 times more efficient than flow-over tubing geometry,
2) a means of providing pressure backing to thin membranes by using a use of a hollow sintered metal or ceramic tube surrounding the membrane,
3) a means of providing further pressure support by surrounding the hollow sintered tube with a metal tube with openings provides for gas and volatile organic compound egress,
4) a means providing the membrane to hold shape regardless of the variation in, or absolute amount of, hydrostatic pressure applied,
5) a means of a compression gasket between the polymer tubing and the tubing adapters wherein this gasket fit prevents leakage of fluids under high hydrostatic pressure into the vacuum chamber,
6) a means of allowing heat transmittance to the gas transmittance structure comprised of the membrane surrounded by the hollow sintered rod within the vacuum chamber,
7) a means for providing for constant and higher temperatures to be applied during the membrane introduction mass spectrometry analysis,
8) a means of providing a very compact membrane introduction mass spectrometry assembly that can be located within the pressure housing of an underwater mass spectrometer instrument,
9) a means providing for ample room for thermal insulation around the device so that low-powered, constant temperatures can be maintained within compact instruments,
10) a means of providing a small vacuum chamber size resulting in low dead space,
11) a means providing for faster and higher-pressure analytical response by a mass spectrometer or other analytical apparatus,
12) a means of performing membrane introduction mass spectrometry analysis at high hydrostatic pressure without fluid leaks into the vacuum space,
13) a means of performing membrane introduction mass spectrometry analysis at high hydrostatic pressure without fluid leaks into the instrument space,
14) a means wherein a pressure supporting tube surrounds the hollow sintered metal or ceramic tube surrounding the membrane provides for increased pressure support for performing membrane introduction mass spectrometry analysis at high hydrostatic pressure without fluid leaks,
15) a means wherein a pressure supporting tube has drilled holes which provide for the ease of transmittance of the gases or volatile organic compounds as molecular flow into the surrounding vacuum chamber,
16) a means wherein a pressure supporting tube has machined slots which provide for the ease of transmittance of the gases or volatile organic compounds as molecular flow into the surrounding vacuum chamber,
17) a means wherein the compact size of a membrane introduction mass spectrometry analysis unit leaves ample room for thermal insulation around the device so that low-powered, constant temperatures can be maintained in instruments where space and power are limited,
18) a means wherein a thermal pressure screw maintains abutment and close contact of the gas transmittance structure with the thermal contact area providing efficient heat transfer from the body of the apparatus to said gas transmittance structure providing for low power operation,
19) a means in which an exposed gas transmittance structure is mounted within a round vacuum chamber endcap providing for direct exposure with the vacuum of said vacuum chamber,
20) a means in which coiled inlet and outlet tubing permit removal of the gas transmittance structure from a round vacuum chamber endcap providing for change-out of the membrane,
21) a means whereby a heater block mounted on the outside of round vacuum chamber endcap provides for membrane introduction mass spectrometry analysis at high, constant temperatures.
